(19) United States
(12) Patent Application Publication
(10) Pub. No.: US 2007/0127422 A1
(43) Pub. Date: Jun. 7, 2007

(54) System and method for computing the position of a mobile device operating in a wireless network

(76) Inventor: John M. Belcea, West Melbourne, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/295,911

(22) Filed: Dec. 7, 2005

(51) Int. Cl. H04Q 7/24

(52) U.S. Cl. 370/338

(57) ABSTRACT

The present invention provides a method for computing the position of a mobile device (200,405) operating in a wireless network (100). The system includes a receiver, adapted to receive respective signals from each of at least four reference devices (410,415,420,425) at the mobile device (405), each respective signal including information representing a Time of Flight between the mobile device (405) and the associated fixed reference device. The system includes a processor (215), to estimate the location of the mobile device (200,405) by computing at least three Apollonius circles (500,600,700) between the mobile device (405) and each of the at least three different pairs of fixed reference devices, wherein the computed Apollonius circles are indicative of the distance between the mobile device (405) and each of the associated fixed reference devices of each pair; and calculating the location of the mobile device (405) as the intersection of the computed Apollonius circles.

### FIELD OF THE INVENTION

The present invention relates generally to wireless communication networks; and more particular to computation of the position of a mobile device operating within an ad-hoc wireless network.

### BACKGROUND

In recent years, a type of mobile communications network known as a “ad-hoc multihopping” network has been developed. In this type of network, each mobile node (i.e. mobile device) is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc multihopping network, further enable the mobile nodes to access fixed networks and thus communicate with other fixed or mobile nodes, such as those on the public switched telephone network (PSTN), and on other networks such as the Internet.

It will be appreciated by those of ordinary skill in the art that the operation of an ad-hoc network includes communication among moving (i.e. mobile) devices that are by definition changing locations. Therefore, it is beneficial to have an accurate method to compute the location of each mobile device within an ad-hoc multihopping wireless network at any given time. It will be appreciated by those of ordinary skill in the art, for example, that a need exists for accurate computation of device locations inside buildings for such device users as firefighters, law enforcement, and the like.

Some methods for computing the location of a wireless mobile device operating in ad-hoc multihopping networks presume that the propagation speed of radio signals is the same as the speed of light. Recent measurements have indicated that the propagation speed of radio signals inside some buildings is actually smaller than the speed of light.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communication network including a plurality of nodes employing a system and method in accordance with an embodiment of the present invention.

FIG. 2 is a block diagram illustrating an example of a node employed in the network shown in FIG. 1 in accordance with an embodiment of the present invention.

FIG. 3 is a flowchart illustrating a method for computing the position of a mobile in accordance with an embodiment of the present invention.

FIGS. 4 through 9 illustrate an exemplary operation of the method of the present invention inside a building.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and system components for computing the position of a mobile device operating in a wireless network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements that does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of computing the position of a mobile device operating in a wireless network described herein. The non-processor circuits may include, but are not limited to, a radio receiver, a radio transmitter, signal drivers, clock circuits, power source circuits, and user input devices. As such, these functions may be interpreted as steps of a method to perform computations of the position of a mobile device operating in a wireless network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The proposed system and method can compute the position of the mobile device regardless of signal propagation speed, therefore it is applicable in any environment: indoor, outdoor, underground, underwater, cosmic space, etc.

The method presented in this disclosure applies, for example, to Mesh Enabled Architecture (MEA) devices that operate in ad-hoc multihopping wireless networks and have the capability to estimate the Time Of Flight (TOF) of radio signals traveling between a mobile device and several fixed references.

The propagation speed of radio signals is dependent on medium permeability, reflectivity, refractivity and conductivity. The propagation speed of radio signals in free space is considered equal with the speed of light or 0.299792458-10⁹ meters per second. Measurements performed inside buildings have identified that the radio signals propagate as one direct signal and several alternative signals. The direct signal that is used for computing the range between the transmitter and the receiver by TOF based methods is affected by very high attenuation when passing through walls. The alternate signals instead, are less attenuated and are received at much higher energy than the direct signal at relatively large distances from the transmitter.

The method of the present invention supposes that the propagation speed of radio signals inside buildings is the same in all directions, although a building is a structure, not a homogeneous mass. This approximation may cause some errors, but the size of those errors is much smaller than considering that the radio signals propagate in all directions inside building at the speed of light. Although the method is specially designed for use inside buildings, it can also be applied for computing the location of a moving ad-hoc terminal in any conditions, as the propagation speed of radio signals is not a parameter of computation.

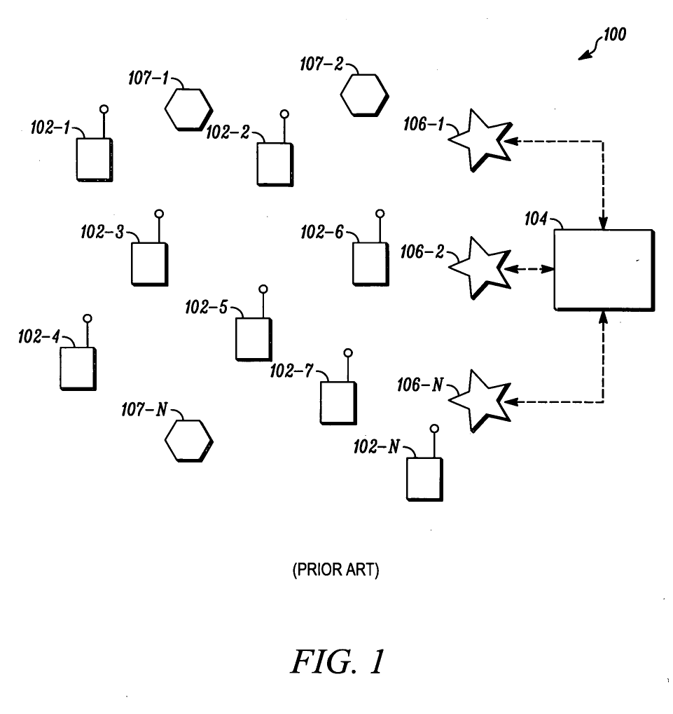

FIG. 1 is a block diagram illustrating an example of an ad-hoc wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The network 100 further can include a plurality of fixed routers 107-1 through 107-n (referred to generally as fixed nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes.

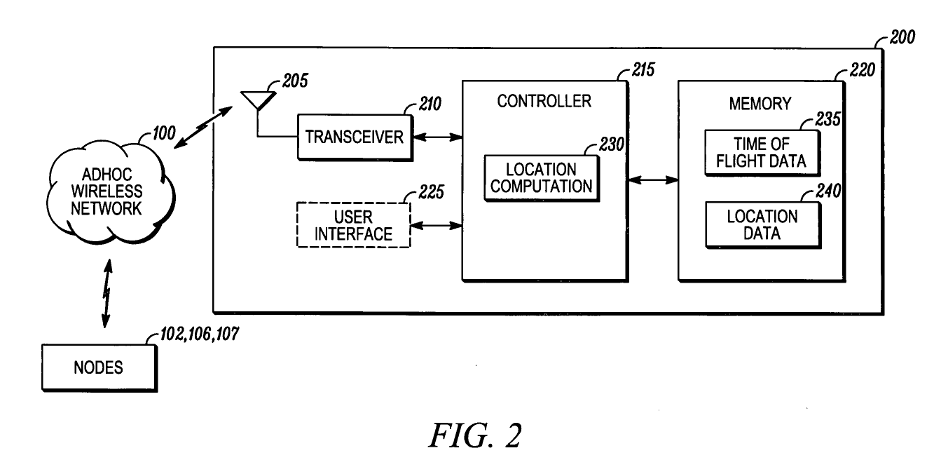

FIG. 2 is an electronic block diagram of one embodiment of the nodes 102, 106, and 107 of FIG. 1. Specifically, FIG. 2 illustrates a node 200 for use with the present invention.

As illustrated, the node 200 includes an antenna 205, a transceiver (or modem) 210, a controller 215, and optionally a user interface 225. The antenna 205 intercepts transmitted signals from one or more nodes 102, 106, 107 within the adhoc wireless network 100 and transmits signals to the one or more nodes 102, 106, 107 within the adhoc wireless network 100.

The antenna 205 is coupled to the transceiver 210, which employs conventional demodulation techniques for receiving and transmitting communication signals, such as packetized signals, to and from the node 200 under the control of the controller 215. The packetized data signals can include, for example, voice, data or multimedia information, and packetized control signals, including node update information. When the transceiver 210 receives a command from the controller 215, the transceiver 210 sends a signal via the antenna 205 to one or more devices within the ad-hoc wireless communications network 100. In an alternative embodiment (not shown), the node 200 includes a receive antenna and a receiver for receiving signals from the ad hoc wireless communications network 100 and a transmit antenna and a transmitter for transmitting signals to the ad-hoc wireless communications network 100. It will be appreciated by one of ordinary skill in the art that other similar electronic block diagrams of the same or alternate type can be utilized for the node 200.

Coupled to the transceiver 210, is the controller 215 utilizing conventional signal-processing techniques for processing received messages. It will be appreciated by one of ordinary skill in the art that additional processors can be utilized as required to handle the processing requirements of the controller 215.

In accordance with the present invention, the controller 215 includes a location computation block 230 for computing the location (position) of one or more nodes 102, 106, 107 within the ad-hoc wireless communication network 100. It will be appreciated by those of ordinary skill in the art that the location computation block 230 can be hard coded or programmed into the node 200 during manufacturing, can be programmed over-the-air upon customer subscription, or can be a downloadable application. It will be appreciated that other programming methods can be utilized for programming the location computation block 230 into the node 200. It will be further appreciated by one of ordinary skill in the art that the location computation block 230 can be hardware circuitry within the node 200. In accordance with the present invention, the location computation block 230 can be contained within the controller 215 as illustrated, or alternatively can be an individual block operatively coupled to the controller 215 (not shown).

To perform the necessary functions of the node 200, the controller 215 is coupled to the memory 220, which preferably includes a random access memory (RAM), a read-only memory (ROM), an electrically erasable programmable read-only memory (EEPROM), and flash memory. The memory 220, in accordance with the present invention, includes storage locations for the storage of Time of Flight data 235, location data 240, and the like.

The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the node 200.

In an optional embodiment, the user interface 225 is coupled to the controller 215. The user interface 225 can include a keypad such as one or more buttons used to generate a button press or a series of button presses. The user interface 225 can also include a voice response system or other similar method of receiving a manual input initiated by the device user. The controller 215, in response to receiving a user input via the user interface 225 performs commands as required. It will be appreciated by those of ordinary skill in the art that the user interface 225 can be utilized to perform various functions and make various operational choices for functioning of the node 200. For example, the user interface 225 can be used to provide inputs to the location computation block 230 for computing the location of a node 102, 106, 107 in accordance with the present invention.

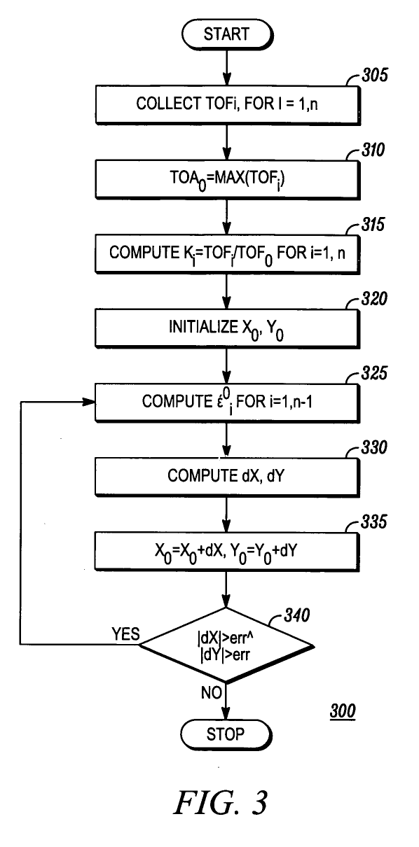

FIG. 3 is a flowchart illustrating a method 300 for computing the position of a mobile in accordance with an embodiment of the present invention. Although four references are strictly required for finding the position of the mobile, in practical operation the number of involved references can be much larger. It helps to minimize the error of the computed position, as all measured TOFᵢ are affected by measurement error.

As illustrated in FIG. 3, the operation begins with Step 305 in which the TOF values from all n+1 references are collected. Next, in Step 310, the reference providing the largest TOF is considered as “number zero”. Next, in Step 315, the values of kᵢ factors are then computed in relation with the largest TOF. Next, in Step 320, the coordinates of the mobile are initialized to some values. These values could be anything, but the previously computed position of the mobile is preferred for reducing the amount of computation. With the next Step 325 starts the iterative process. It is executed until the corrections have values smaller than a specified precision. With the computational method of the present invention, are computed the individual errors to each reference \acute{ε}⁰ᵢ using, for example, equation 7 as described below. Next, in Step 330, are computed the corrections dX and dY of the current coordinates using, for example, equation 15 described below. These corrections are then applied to previous coordinates in Step 335. Next, in Step 340, it is determined if any of the applied corrections is too large. When an applied correction is too large, the operation cycles back to Step 325 and the next iteration is executed. If the corrections are small enough, the process stops.

The method presented in this disclosure provides the mobile coordinates by minimizing the sum of the square of errors (Least Square Method). The same results can be found using any other method that minimizes the sum of the square of errors or uses another optimization criterion (a likeability function, for example). Furthermore, in some particular applications the weighted minimization criterion can be applied, where each individual error is weighted according to a predefined weighting method.

Further explanation of the process of FIG. 3 follows herein.

The estimation of the distance between two terminals operating in an ad-hoc multihopping network has been described in U.S. Pat. No. 6,768,730 and U.S. Pat. No. 6,453,168. These methods compute the range between terminals by multiplying the Time-Of-Flight with 0.299792458-10⁹, the propagation speed of radio waves in free space.

A method for computing the position of a mobile terminal operating in an ad-hoc multihopping network is presented in U.S. Pat. No. 6,728,545.

The distance ρᵢ between a mobile device of unknown coordinates (X, Y) and a fixed reference device with known coordinates (xᵢ, y) verifies the relation:
ρ²ᵢ=(X−xᵢ)²+(Y−yᵢ)² (1)

As mentioned before, the position of the mobile is not known, therefore the computed distance ρᵢ is a function of the unknown values of X and Y.

The range rᵢ between the same two terminals can be computed from the measured time of flight τᵢ.
rᵢ=τᵢ*c (2)

In the above equation, c is the propagation speed of radio signals that is 0.299792458-10⁹ in free space, or some other unknown value in other conditions.

Supposing that the measurements and the propagation speed are correct, the distance ρᵢ between the mobile terminal and the reference is the same as the measured distance rᵢ.
rᵢ=ρᵢ (3)

It means that we can compute a factor k_{i,j} associated with the time-of-flight τᵢ and τⱼ measured between the mobile and two fixed references i and j:

$${k}_{i , j} = \frac{{r}_{i}}{{r}_{j}} = \frac{{τ}_{i} * c}{{τ}_{j} * c} = \frac{{τ}_{i}}{{τ}_{j}} = \frac{{ρ}_{i}}{{ρ}_{j}} \qquad ( 4 )$$

It results that the value of the k_{i,j} factor can be computed from the measured time-of-flight values τᵢ and τⱼ and is not dependent on the propagation speed of the signal. Replacing the computed distances with their mathematical expressions, we get:

$${k}_{i , j}^{2} = \frac{{( X - {x}_{i} )}^{2} + {( Y - {y}_{i} )}^{2}}{{( X - {x}_{j} )}^{2} + {( Y - {y}_{j} )}^{2}} \qquad ( 5 )$$

In equation (, the only unknown entities are X and Y, the coordinates of the mobile terminal.

Equation ( is the geometrical locus of all points in the plane that verify the property that their distances to two fixed references ρᵢ and pⱼ are in the fixed proportion presented in equation (.

This locus is known as the Apollonius circle for more than 2200 years. The analytical equation of this geometric locus is:

$${( X - \frac{{x}_{i} - {k}_{i , j}^{2} {x}_{j}}{1 - {k}_{i , j}^{2}} )}^{2} + {( Y - \frac{{y}_{i} - {k}_{i , j}^{2} {y}_{j}}{1 - {k}_{i , j}^{2}} )}^{2} = ( \frac{{k}_{i , j}}{1 - {k}_{i , j}^{2}} ) ( {( {x}_{i} + {x}_{j} )}^{2} + {( {y}_{i} + {y}_{j} )}^{2} ) \qquad ( 6 )$$

The Apollonius circle has the center in

$$( \frac{{x}_{i} - {k}_{i , j}^{2} {x}_{j}}{1 - {k}_{i , j}^{2}} , \frac{{y}_{i} - {k}_{i , j}^{2} {y}_{j}}{1 - {k}_{i , j}^{2}} )$$

$$\frac{{k}_{i , j}}{1 - {k}_{i , j}^{2}} \sqrt{{( {x}_{i} + {x}_{j} )}^{2} + {( {y}_{i} + {y}_{j} )}^{2}} .$$

and a radius

If the two distances between mobile and both reference points are almost the same, the value of k_{i,j} is close to one. In this case, the radius of Apollonius circle becomes very large and the center of the center of the circle moves towards infinity. The point M′ in Error! Reference source not found. moves close to the

$${ɛ}_{i} ( X , Y ) = {( X - \frac{{x}_{i} - {k}_{i}^{2} {x}_{0}}{1 - {k}_{i}^{2}} )}^{2} + {( Y - \frac{{y}_{i} - {k}_{i}^{2} {y}_{0}}{1 - {k}_{i}^{2}} )}^{2} - {( \frac{{k}_{i}}{1 - {k}_{i}^{2}} )}^{2} ( {( {x}_{i} + {x}_{0} )}^{2} {( {y}_{i} + {y}_{0} )}^{2} ) i = 1 , 2 , … n \qquad ( 7 )$$

middle of the segment, while the point M″ moves towards infinity. At the limit, when k=1, the circle degenerates in the perpendicular bisector of the segment connecting the two reference points.

Lets now number all references available in an instance with i=0, 1, 2, . . . . n. In this set are n+1 references from which we can build n Apollonius circles. For simplification of the computation, we select the first range (i=0) as reference (same as “j” in previous text) and ignore the index zero. It means that instead of using k_{i,0} we will write kᵢ, with the same meaning as before. Because the coordinates of the mobile are not known and the measurements are affected by errors that is computed from equation ( as follows:

In equation (, the errors εᵢ(X,Y) for i=1, 2, 3, . . . n have values depending on the coordinates X and Y and the measurement errors. The most probable position (X, Y) of the mobile terminal can be found by minimizing the expression (LSM):

$$E ( X , Y ) = {\sum }_{i = 1}^{n} {ɛ}_{i}^{2} ( X , Y ) i = 1 , 2 , … n \qquad ( 8 )$$

The values of X and Y where the function E(X, Y) has the minimum value, also verify:

$$\{ \begin{matrix}Fx ( X , Y ) = \frac{\partial E ( X , Y )}{\partial X} = 2 {\sum }_{i = 1}^{n} ( \frac{\partial {ɛ}_{i}}{\partial X} {ɛ}_{i} ) = 0 \\ Fy ( X , Y ) = \frac{\partial E ( X , Y )}{\partial Y} = 2 {\sum }_{i = 1}^{n} ( \frac{\partial {ɛ}_{i}}{\partial Y} {ɛ}_{i} ) = 0\end{matrix} \qquad ( 9 )$$

The derivatives of errors are computed as follows:

$$\begin{matrix}\frac{\partial {ɛ}_{i}}{\partial X} = \frac{\partial ( \begin{matrix}{( X - \frac{{x}_{i} - {k}_{i}^{2} {x}_{0}}{1 - {k}_{i}^{2}} )}^{2} + \\ {( Y - \frac{{y}_{i} - {k}_{i}^{2} {y}_{0}}{1 - {k}_{i}^{2}} )}^{2} - \\ ( \frac{{k}_{i}}{1 - {k}_{i}^{2}} ) ( \begin{matrix}{( {x}_{i} + {x}_{0} )}^{2} + \\ {( {y}_{i} + {y}_{0} )}^{2}\end{matrix} )\end{matrix} )}{\partial x} \\ = 2 ( X - \frac{{x}_{i} - {k}_{i}^{2} {x}_{0}}{1 - {k}_{i}^{2}} )\end{matrix} i = 1 , 2 , … n \\ \frac{\partial {ɛ}_{i}}{\partial Y} = 2 ( Y \frac{{y}_{i} - {k}_{i}^{2} {y}_{0}}{1 - {k}_{i}^{2}} ) \qquad ( 10 )$$

After ignoring the constant factors, the system of equations ( can be written as:

$$\{ \begin{matrix}Fx ( X , Y ) = {\sum }_{i = 1}^{n} ( ( X - \frac{{x}_{i} - {k}_{i}^{2} {x}_{0}}{1 - {k}_{i}^{2}} ) {ɛ}_{i} ) = 0 \\ Fy ( X , Y ) = {\sum }_{i = 1}^{n} ( ( Y - \frac{{y}_{i} - {k}_{i}^{2} {y}_{0}}{1 - {k}_{i}^{2}} ) {ɛ}_{i} ) = 0\end{matrix} \qquad ( 11 )$$

The system of equations ( is not linear in X and Y.

The classic method for solving a non linear system of equations is to make a linear approximation of the problem and select an approximate solution (X₀, Y₀). The iterative process uses the linear approximation for iteratively computing corrections (dX, dY) that improve the precision of the approximation.

One method for building a linear approximation of the problem is to consider only the linear terms of the Taylor series associated to the system of equations (.

$$\{ \begin{matrix}\begin{matrix}F x ( X , Y ) ≅ Fx ( {X}_{0} , {Y}_{0} ) + \frac{\partial Fx ( X , Y )}{\partial X} {\vert}_{\begin{matrix}X = {X}_{0} \\ Y = {Y}_{0}\end{matrix}} ⅆ X + \\ \frac{\partial Fx ( X , Y )}{\partial Y} {\vert}_{\begin{matrix}X = {X}_{0} \\ Y = {Y}_{0}\end{matrix}} ⅆ y\end{matrix} \\ Fy ( X , Y ) ≅ Fy ( {X}_{0} , {Y}_{0} ) + \frac{\partial Fy ( X , Y )}{\partial X} {\vert}_{\begin{matrix}X = {X}_{0} \\ Y = {Y}_{0}\end{matrix}} ⅆ X + \\ \frac{\partial Fy ( X , Y )}{\partial Y} {\vert}_{\begin{matrix}X = {X}_{0} \\ Y = {Y}_{0}\end{matrix}} ⅆ y\end{matrix} \qquad ( 12 )$$

Replacing Fx and Fy with expressions from equation ( and performing the derivatives:

$$\{ \begin{matrix}{\sum }_{i = 1}^{n} ( {X}_{0} - \frac{{x}_{i} - {k}_{i}^{2} {x}_{0}}{1 - {k}_{i}^{2}} ) {ɛ}_{i}^{0} + {\sum }_{i = 1}^{n} ( {ɛ}_{i}^{0} + 2 {( {X}_{0} - \frac{{x}_{i} - {k}_{i}^{2} {x}_{0}}{1 - {k}_{i}^{2}} )}^{2} ) ⅆ X + \\ {\sum }_{i = 1}^{n} ( {X}_{0} - \frac{{x}_{i} - {k}_{i}^{2} {x}_{0}}{1 - {k}_{i}^{2}} ) ( {Y}_{0} - \frac{{y}_{i} - {k}_{i}^{2} {y}_{0}}{1 - {k}_{i}^{2}} ) ⅆ Y = 0 \\ {\sum }_{i = 1}^{n} ( {Y}_{0} - \frac{{x}_{i} - {k}_{i}^{2} {y}_{0}}{1 - {k}_{i}^{2}} ) {ɛ}_{i}^{0} + \\ {\sum }_{i = 1}^{n} ( {X}_{0} - \frac{{x}_{i} - {k}_{i}^{2} {x}_{0}}{1 - {k}_{i}^{2}} ) ( {Y}_{0} - \frac{{y}_{i} - {k}_{i}^{2} {y}_{0}}{1 - {k}_{i}^{2}} ) dX + \\ {\sum }_{i = 1}^{n} ( {ɛ}_{i}^{0} + 2 {( {Y}_{0} - \frac{{y}_{i} - {k}_{i}^{2} {y}_{0}}{1 - {k}_{i}^{2}} )}^{2} ) ⅆ Y = 0\end{matrix} \qquad ( 13 )$$

After moving known elements on the right side of the equal sign, the system of equations is:

$$\{ \begin{matrix}{\sum }_{i = 1}^{n} ( {ɛ}_{i}^{0} + 2 {( {X}_{0} - \frac{{x}_{i} - {k}_{i}^{2} {x}_{0}}{1 - {k}_{i}^{2}} )}^{2} ) ⅆ X + \\ {\sum }_{i = 1}^{n} ( {X}_{0} - \frac{{x}_{i} - {k}_{i}^{2} {x}_{0}}{1 - {k}_{i}^{2}} ) ( {Y}_{0} \frac{{y}_{i} - {k}_{i}^{2} {y}_{0}}{1 - {k}_{i}^{2}} ) ⅆ Y = - \\ {\sum }_{i = 1}^{n} ( {X}_{0} - \frac{{x}_{i} - {k}_{i}^{2} {x}_{0}}{1 - {k}_{i}^{2}} ) {ɛ}_{i}^{0} \\ {\sum }_{i = 1}^{n} ( {X}_{0} - \frac{{x}_{i} {k}_{i}^{2} {x}_{0}}{1 - {k}_{i}^{2}} ) ( {Y}_{0} - \frac{{y}_{i} - {k}_{i}^{2}}{1 - {k}_{i}^{2}} ) ⅆ X + \\ {\sum }_{i = 1}^{n} ( {ɛ}_{i}^{0} + 2 {( {Y}_{0} \frac{{y}_{i} - {k}_{i}^{2} {y}_{0}}{1 - {k}_{i}^{2}} )}^{2} ) ⅆ Y = - {\sum }_{i = 1}^{n} ( {Y}_{0} - \frac{{x}_{i} - {k}_{i}^{2} {y}_{0}}{1 - {k}_{i}^{2}} ) {ɛ}_{i}^{0}\end{matrix} \qquad ( 14 )$$

The value ε⁰ᵢ is the error computed with equation ( when X=X₀ and Y=Y₀.

If one of the ranges is equal with the reference range, the corresponding Apollonius circle degenerate in the perpendicular bisector of the line connecting the two reference points. For preventing overflow during the computation, equation ( should be changed in:

$$\{ \begin{matrix}{\sum }_{i = 1}^{n} ( {{ɛ}_{i}^{0} ( 1 - {k}_{i}^{2} )}^{2} + 2 {( {X}_{0} ( 1 - {k}_{i}^{2} ) - ( {x}_{i} - {k}_{i}^{2} {x}_{0} ) )}^{2} ) ⅆ X + \\ {\sum }_{i = 1}^{n} ( {X}_{0} ( 1 - {k}_{i}^{2} ) - ( {x}_{i} - {k}_{i}^{2} {x}_{0} ) ) ( {Y}_{0} ( 1 - {k}_{i}^{2} ) - ( {y}_{i} - {k}_{i}^{2} {y}_{0} ) ) ⅆ Y = - \\ {\sum }_{i = 1}^{n} ( {X}_{0} ( 1 - {k}_{i}^{2} ) - ( {x}_{i} - {k}_{i}^{2} {x}_{0} ) ) {ɛ}_{i}^{0} \\ {\sum }_{i = 1}^{n} ( {X}_{0} ( 1 - {k}_{i}^{2} ) - ( {x}_{i} - {k}_{i}^{2} {x}_{0} ) ) ( {Y}_{0} ( 1 - {k}_{i}^{2} ) - ( {y}_{i} - {k}_{i}^{2} {y}_{0} ) ) ⅆ X + \\ {\sum }_{i = 1}^{n} ( {ɛ}_{i}^{0} ( 1 - {k}_{i}^{2} ) + 2 {( {Y}_{0} ( 1 - {k}_{i}^{2} ) - ( {y}_{i} - {k}_{i}^{2} {y}_{0} ) )}^{2} ) ⅆ Y = - \\ {\sum }_{i = 1}^{n} ( {Y}_{0} ( 1 - {k}_{i}^{2} ) - ( {x}_{i} - {k}_{i}^{2} {y}_{0} ) ) {ɛ}_{i}^{0}\end{matrix} \qquad ( 15 )$$

The method can be extended easily for computing three-dimensional coordinates (X, Y, Z).

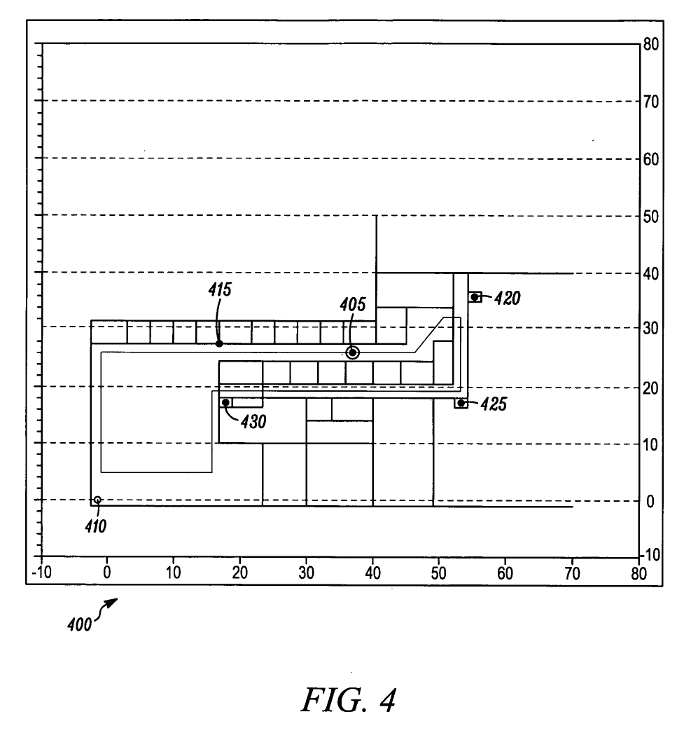

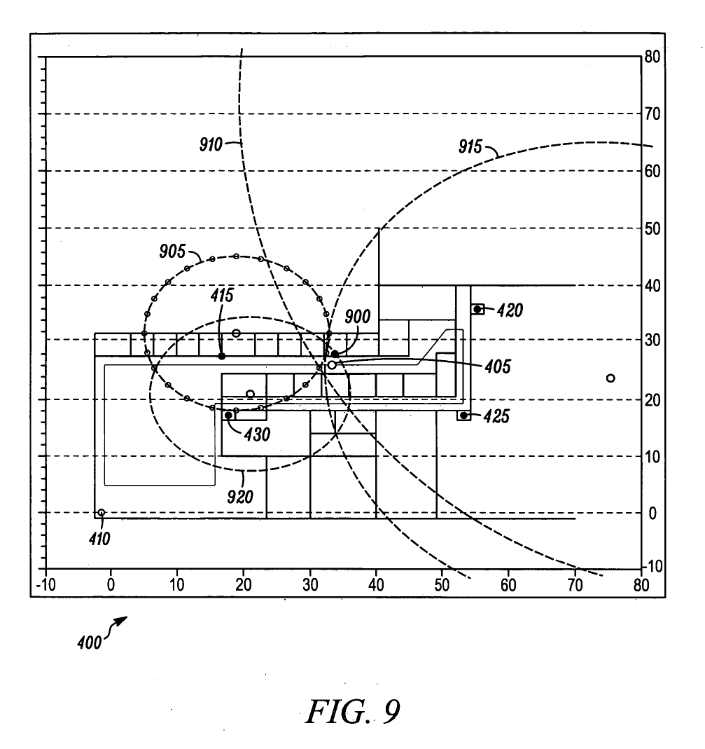

FIGS. 4 through 9 illustrate an exemplary operation of the method of the present invention inside a building. FIGS. 4 through 8 are processed using simulated data. FIG. 9 illustrates the results using measured data.

FIG. 4 illustrates the map of an exemplary office building 400. A mobile device 405 is located within the office building 400. Further, five references (410, 415, 420, 425 and 430) are located within the office building 400. Each of the five references preferably are fixed location references for purposes of computing the location of the mobile device 405. The mobile device 405 and each of the five references (410, 415, 420, 425 and 430) communicate within a wireless communication network. The wireless communication network, for example, can be an ad-hoc multihopping wireless network. In accordance with an embodiment of the present invention, each of the five references (410, 415, 420, 425 and 430) further has a Time of Flight (TOF) to the mobile device 405 associated therewith. For example, the first reference 410 has a first Time of Flight between the mobile device 405 and the first reference 410. The second reference 415 has a second Time of Flight between the mobile device 405 and the second reference 415. The third reference 420 has a third Time of Flight between the mobile device 405 and the third reference 420. The fourth reference 425 has a fourth Time of Flight between the mobile device 405 and the fourth reference 425. The fifth reference 430 has a fifth Time of Flight between the mobile device 405 and the fifth reference 430. The Time of Flight between each reference and the mobile device 405 can be measured as is known in the art.

Although the example of FIGS. 4 through 9 illustrates that of an office building, it will be appreciated by those of ordinary skill in the art that the method and system of the present invention can be utilized in any environment such as an indoor environment, an outdoor environment, an underground environment, a celestial environment, and an underwater environment.

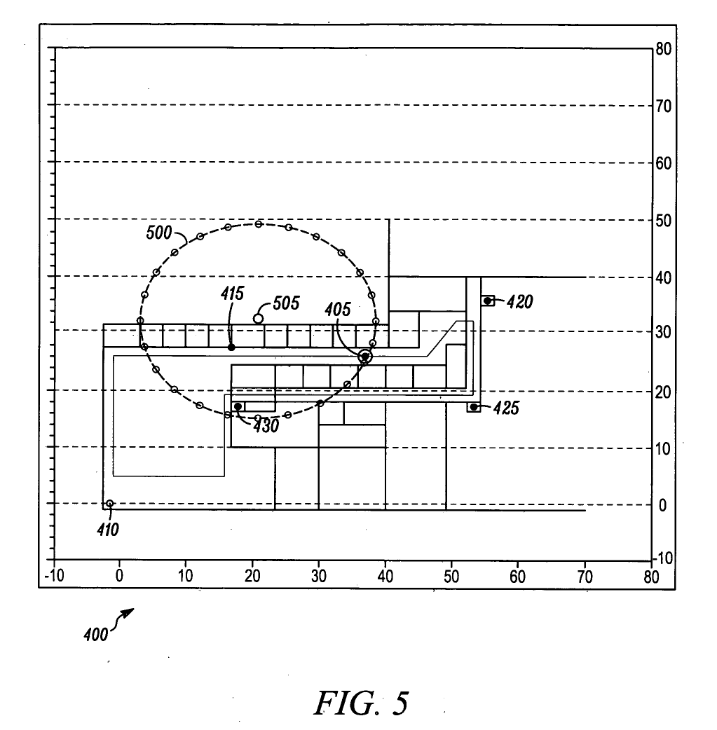

FIG. 5 illustrates a first step of an embodiment of the method of the present invention. Specifically, FIG. 5 illustrates a first Apollonius circle 500 representing a circle of possible locations of the mobile device 405. The first Apollonius circle 500, for example, is computed using a position of the first reference 410 and a position of the second reference 415. For example, the first Apollonius circle 500, in accordance with the present invention, can be computed by measuring a first Time Of Flight between the mobile device 405 and the first reference 410; measuring a second Time Of Flight between the mobile device 405 and the second reference 415; and computing the first Appollonius circle 500 using the first Time Of Flight, the second Time of Flight, the first position of the first reference 410, and the second position of the second reference 415. The center 505 of the first Apollonius circle 500 is illustrated as an empty small circle. It will be appreciated by those of ordinary skill in the art that the first reference 410 and the second reference 415 are both on the same line with the center 505 of the first Apollonius circle 500.

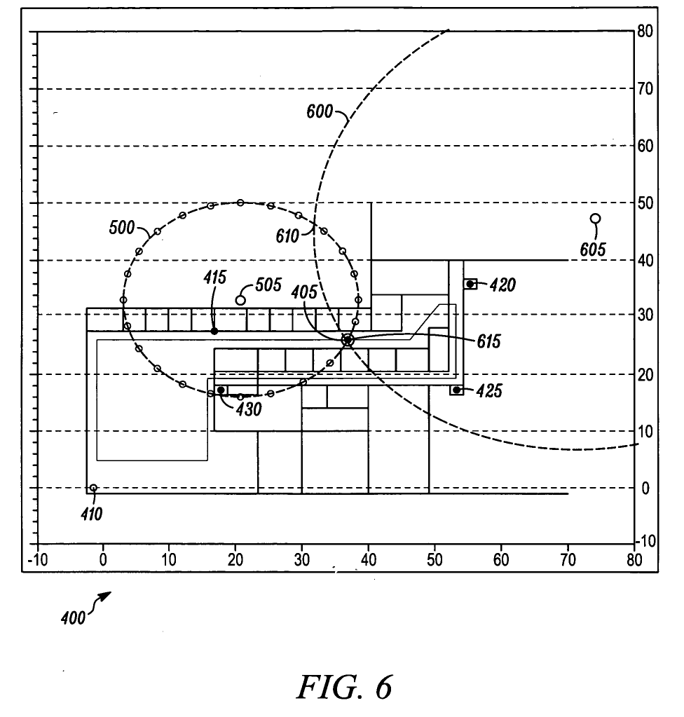

FIG. 6 illustrates a second step of an embodiment of the method of the present invention. Specifically, FIG. 6 illustrates a second Apollonius circle 600 having a center 605 representing a circle of possible locations of the mobile device 405. The second Apollonius circle 600, for example, is computed by measuring a third Time Of Flight between the mobile device 405 and the third reference 420; and computing the second Apollonius circle 600 using the third Time of Flight and one of a Time Of Flight group comprising the first Time Of Flight of the first reference 410 and the second Time Of Flight of the second reference 415. For example, the second Apollonius circle 600 as illustrated is computed using the first Time of Flight of the first reference 410 and the third Time of Flight of the third reference 420. In one embodiment, a first largest Time of Flight reference is selected as the largest Time of Flight calculated for the first reference 410 having the first Time of Flight and the second reference 415 having the second Time of Flight; and then utilized in computing the second Apollonius circle 600. As illustrated in FIG. 6, there are two intersection points (610, 615) of the first Apollonius circle 500 and the second Apollonius circle 600. One of these two intersection points (610, 615) is the location of the mobile device 405.

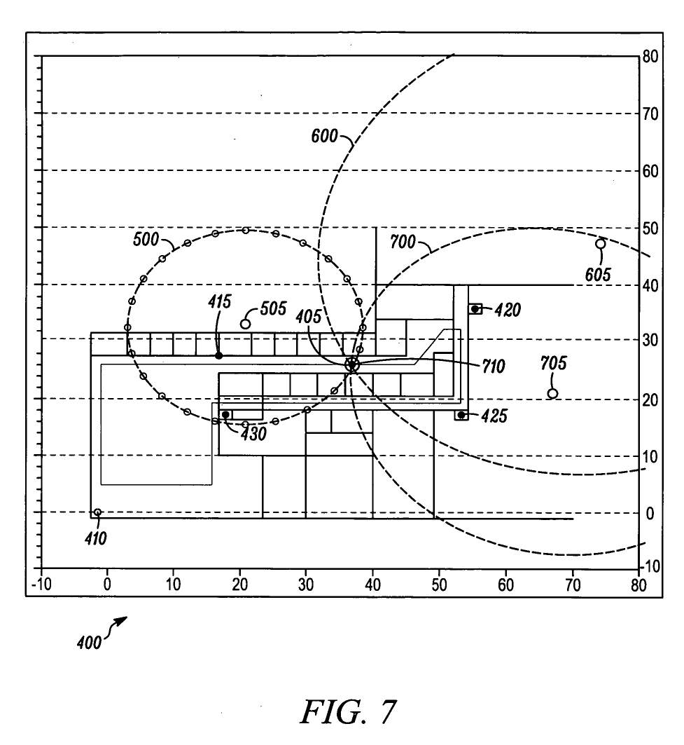

FIG. 7 illustrates a further step of an embodiment of the method of the present invention. Specifically, FIG. 7 illustrates a third Apollonius circle 700 having a center 705 representing a circle of possible locations of the mobile device 405. The third Apollonius circle 700, for example, is computed by measuring a fourth Time Of Flight between the mobile device 405 and the fourth reference 425; and computing the third Apollonius circle 700 using the fourth Time Of Flight of the fourth reference 425 and one of a Time Of Flight group comprising the first Time of Flight of the first reference 410, the second Time of Flight of the second reference 415, and the third Time of Flight of the third reference 420. For example, as illustrated in FIG. 7, the third Apollonius circle 700 is computed using the first Time of Flight of the first reference 410 and the fourth Time of Flight of the fourth reference 425. In one embodiment, a second largest Time of Flight reference is selected as the largest Time of Flight calculated for the first reference 410 having the first Time of Flight, the second reference 415 having the second Time of Flight, and the third reference 420 having the third Time of Flight; and then utilized in computing the third Apollonius circle 700. As illustrated in FIG. 7, there is one intersection point 710 of the first Apollonius circle 500, the second Apollonius circle 600, and the third Apollonius circle 700. The intersection point 710 is the location of the mobile device 405.

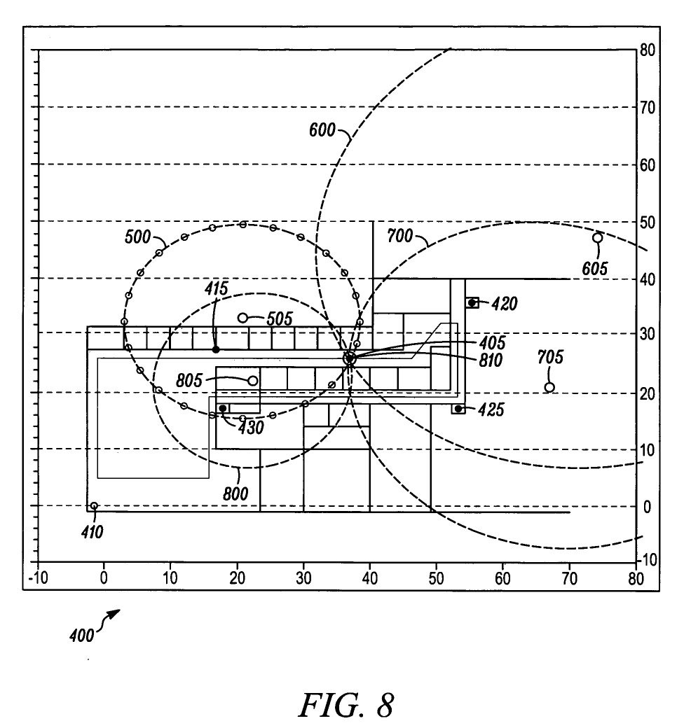

It will be appreciated by those of ordinary skill in the art that at least four references are required for calculating the location of the mobile device in accordance with the present invention. However, it will further be appreciated that additional references can be utilized for calculation accuracy. FIG. 8 illustrates a fourth Apollonius circle 800 having a center 805 representing a circle of possible locations of the mobile device 405. The fourth Apollonius circle 800, for example, is computed by measuring a fifth Time Of Flight between the mobile device 405 and the fifth reference 430; and computing the fourth Apollonius circle 800 using the fifth Time Of Flight of the fifth reference 430 and one of a Time Of Flight group comprising the first Time of Flight of the first reference 410, the second Time of Flight of the second reference 415, the third Time of Flight of the third reference 420, and a fourth Time of Flight of the fourth reference 425. For example, as illustrated in FIG. 8, the fourth Apollonius circle 800 is computed using the first Time of Flight of the first reference 410 and the fifth Time of Flight of the fifth reference 430. In one embodiment, a third largest Time of Flight reference is selected as the largest Time of Flight calculated for the first reference 410 having the first Time of Flight, the second reference 415 having the second Time of Flight, the third reference 420 having the third Time of Flight, and the fourth reference 425 having the fourth Time of Flight; and then utilized in computing the fourth Apollonius circle 800. As illustrated in FIG. 8, there is one intersection point 810 of the first Apollonius circle 500, the second Apollonius circle 600, the third Apollonius circle 700, and the fourth Apollonius circle 800. The intersection point 810 is the location of the mobile device 405.

FIG. 9 illustrates a measured example of the present invention. As illustrated in FIG. 9, a computed position 900 of the mobile device using four Apollonius circles (905, 910, 915, and 920) is slightly different from an actual position of the mobile device 405. The four circles (905, 910, 9015, and 920) do not intersect exactly, as individual TOF measured values can be affected by errors as illustrated in the example of FIG. 9. The algorithm computes the most probable position of the mobile device 405, by minimizing the sum of square of errors. In the case presented in FIG. 9, the position of the mobile device computed with Apollonius circles has been adjusted using the method presented in United States Patent Application 2005/0186966 entitled “Real-time system and method for improving the accuracy of the computed location of mobile subscribers in a wireless ad-hoc network using a low speed central processing unit” the contents of which is incorporated by reference herein.

Although the present invention is described previously herein with respect to a two dimensional location example, it will be appreciated by those of ordinary skill in the art that a three-dimensional application is also within the scope of the invention. For example, to determine a three dimensional location of a mobile device operating in a wireless communication network, the operation in one embodiment can include providing at least five fixed reference devices within the wireless communication network; computing at least four Apollonius spheres between the mobile device and each of the at least four different pairs of fixed reference devices, wherein the computed Apollonius spheres are indicative of the distance between the mobile device and each of the associated fixed reference devices of each pair; and calculating the three dimensional location of the mobile device as the intersection of the computed Apollonius spheres.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for determining a location of a mobile device operating in a wireless communication network comprising the steps of:
providing at least four fixed reference devices within the wireless communication network;
computing at least three Apollonius circles between the mobile device and each of the at least three different pairs of fixed reference devices, wherein the computed Apollonius circles are indicative of the distance between the mobile device and each of the associated fixed reference devices of each pair; and
calculating the location of the mobile device as the intersection of the computed Apollonius circles.

2. A method for determining a location of a mobile device operating in a wireless communication network as claimed in claim 1, wherein each Apollonius circle represents a circle of possible locations of the mobile device.

3. A method for determining a location of a mobile device operating in a wireless communication network as claimed in claim 1, further comprising prior to the computing step, for each of the provided reference, the step of:
measuring the time of flight between the mobile device and the reference for use in the computing step.

4. A method for determining a location of a mobile device operating in a wireless communication network as claimed in claim 1, wherein the computing step comprises:
measuring a first Time Of Flight between the mobile device and a first reference;
measuring a second Time Of Flight between the mobile device and a second reference;
computing a first Apollonius circle using the first Time Of Flight, the second Time of Flight, a first position of the first reference, and a second position of the second reference;
measuring a third Time Of Flight between the mobile device and a third reference;
computing a second Apollonius circle using the third Time of Flight and one of a Time Of Flight group comprising the first Time Of Flight and the second Time Of Flight;
measuring a fourth Time Of Flight between the mobile device and the fourth reference; and
computing a third Apollonius circle using the fourth Time Of Flight and one of a Time Of Flight group comprising the first Time of Flight, the second Time of Flight, and the third Time of Flight.

5. A method for determining a location of a mobile device operating in a wireless communication network as claimed in claim 4, wherein the calculating step comprises:
calculating the location of the mobile device as the intersection of the first, second, and third Apollonius circles.

6. A method for determining a location of a mobile device operating in a wireless communication network as claimed in claim 1, wherein the computing step comprises:
measuring a first Time of Flight between the mobile device and a first reference;
measuring a second Time of Flight between the mobile device and a second reference;
computing a first Apollonius circle using the first Time of Flight and the second Time of Flight;
measuring a third Time of Flight between the mobile device and a third reference;
selecting a first largest Time of Flight reference from a Time of Flight reference group comprising the first reference having the first Time of Flight and the second reference having the second Time of Flight;
computing a second Apollonius circle using the third Time of Flight and the Time of Flight of the first largest Time of Flight reference;
measuring a fourth Time of Flight between the mobile device and a fourth reference;
selecting a second largest Time of Flight reference from a Time of Flight group comprising the first reference having the first Time of Flight, the second reference having the second Time of Flight, and the third reference having the third Time of Flight; and
computing a third Apollonius circle using the fourth Time of Flight and the Time of Flight of the second largest Time of Flight reference.

7. A method for determining a location of a mobile device operating in a wireless communication network as claimed in claim 1, wherein the wireless communication network is an ad hoc multihopping wireless network.

8. A method for determining a location of a mobile device operating in a wireless communication network as claimed in claim 1, wherein communication within the wireless communication network includes communication within one or more of a group of environments comprising an indoor environment, an outdoor environment, an underground environment, a celestial environment, and an underwater environment.

9. A method for determining a location of a mobile device operating in a wireless communication network as claimed in claim 1, wherein the estimating method is independent of a speed of propagation of communication signal within the wireless communication network.

10. A system for determining a location of a mobile device in a wireless communications network, comprising:
a receiver, adapted to receive respective signals from each of at least four reference devices at the mobile device, each respective signal including information representing a Time of Flight between the mobile device and the associated fixed reference device; and
a processor, adapted to estimate the location of the mobile device by:
computing at least three Apollonius circles between the mobile device and each of at least three different pairs of fixed reference devices, wherein the computed Apollonius circles are indicative of the distance between the mobile device and each of the associated fixed reference devices of each pair; and
calculating the location of the mobile device as the intersection of the computed Apollonius circles.

11. A system for determining a location of a mobile device operating in a wireless communication network as claimed in claim 10, wherein each Apollonius circle represents a circle of possible locations of the mobile device.

12. A system for determining a location of a mobile device operating in a wireless communication network as claimed in claim 10, wherein the processor is further adapted to determine the Time of Flight between the mobile device and each of the references for use in computing the three Apollonius Circles.

13. A system for determining a location of a mobile device operating in a wireless communication network as claimed in claim 10, wherein the processor is adapted to compute the three Apollonius Circles by:
measuring a first Time of Flight between the mobile device and a first reference;
measuring a second Time of Flight between the mobile device and a second reference;
computing a first Apollonius circle using the first TOF and the second Time of Flight;
measuring a third Time of Flight between the mobile device and a third reference;
computing a second Apollonius circle using the third Time of Flight and one of a Time of Flight group comprising the first Time of Flight and the second Time of Flight;
measuring a fourth Time of Flight between the mobile device and a fourth reference; and
computing a third Apollonius circle using the fourth Time of Flight and one of a Time of Flight group comprising the first Time of Flight, the second Time of Flight, and the third Time of Flight.

14. A system for determining a location of a mobile device operating in a wireless communication network as recited in claim 13, wherein the processor is further adapted to calculate the location of the mobile device as the intersection of the first, second, and third Apollonius circles.

15. A system for determining a location of a mobile device operating in a wireless communication network as recited in claim 10, wherein the processor is adapted to:
measure a first Time of Flight between the mobile device and a first reference;
measure a second Time of Flight between the mobile device and a second reference;
compute a first Apollonius circle using the first Time of Flight and the second Time of Flight;
measure a third Time of Flight between the mobile device and a third reference;
select a first largest Time of Flight reference from a Time of Flight reference group comprising the first reference having the first Time of Flight and the second reference having the second Time of Flight;
compute a second Apollonius circle using the third Time of Flight and the Time of Flight of the first largest Time of Flight reference;
measure a fourth TOF between the mobile device and a fourth reference;
select a second largest TOF reference from a TOF group comprising the first TOF, the second TOF, and the third TOF; and
compute a third Apollonius circle using the fourth TOF and the second largest TOF reference.

16. A system for determining a location of a mobile device operating in a wireless communication network as recited in claim 10, wherein the wireless communication network is an ad hoc multihopping wireless network.

17. A system for determining a location of a mobile device operating in a wireless communication network as recited in claim 10, wherein communication within the wireless communication network includes communication within one or more of a group of environments comprising an indoor environment, an outdoor environment, an underground environment, a celestial environment, and an underwater environment.

18. A method for determining a three dimensional location of a mobile device operating in a wireless communication network comprising the steps of:
providing at least five fixed reference devices within the wireless communication network;
computing at least four Apollonius spheres between the mobile device and each of the at least four different pairs of fixed reference devices, wherein the computed Apollonius spheres are indicative of the distance between the mobile device and each of the associated fixed reference devices of each pair; and
calculating the three dimensional location of the mobile device as the intersection of the computed Apollonius spheres.
